(19) United States
(12) Patent Application Publication
(10) Pub. No.: US 2006/0143465 A1
(43) Pub. Date: Jun. 29, 2006

(54) Method protecting a computer by adding a lock function to a mobile phone universal interface

(75) Inventors: Cheng-Shing Lai, Taipei (TW); Ke Guan, Nankng (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/167,085

(22) Filed: Jun. 28, 2005

(30) Foreign Application Priority Data
Dec. 29, 2004 (TW) 093141080

(51) Int. Cl. H04L 9/00

(52) U.S. Cl. 713/182

(57) ABSTRACT

The present invention is to provide a method of protecting a computer by adding a lock function to a mobile phone universal interface comprising the steps of installing a lock software in a mobile phone for locking the universal interface, and installing a driver program in the computer for driving the lock software, so that after the lock software of the mobile phone is functioning and the mobile phone is connected to the computer through a transmission wire, the protection program is run. After the computer is disconnected from the mobile phone, the computer displays an inquiry window to ask whether to lock the computer or not, and will be activated into a normal mode until said mobile phone is reconnected and is confirmed as a unique identity.

### FIELD OF THE INVENTION

This invention relates to a method of protecting a computer and more particularly to a method of protecting a computer by adding a lock function to a mobile phone universal interface.

### BACKGROUND OF THE INVENTION

As the information related technology is developed rapidly, transmission interfaces are extensively used in consumer electronic products, mobile phones, laptop computers and information home appliances and Universal Series Bus (USB) has now become a main application for personal computers.

Users often complain about the complexity and difficulty of connecting a computer with its peripheral devices, and thus manufacturers proposed a standard interface to simplify the existing connections between a PC and peripherals. Such concept was widely accepted, and the USB standard is established to provide a simple and low-cost standard for users, and the USB standard just uses a single transmission wire to connect various kinds of peripherals in series and overcome the issue of having a bunch of tangled wires at the back of a computer. Further, the interface communication protocol also can automatically detect the installation of peripheral devices without rebooting the personal computer or having a complicated installation procedure, so as to achieve the hot-swapping (Plug-n-Play, PnP) of various peripherals.

USB is a global standard universal specification for serial devices including keyboards, pointing devices, joysticks, and USB supports a high-speed compressed audio/video information transmission. With the features of a simple physical connecting structure of the USB interface, a good expandability, and a hot swapping function, the USB is the most popular data transmission interface and extensively used in PCs, peripherals, mobile phones and consumer electronic products, which takes USB as an I/O interface.

As the mobile phone is portable and most of the mobile phones have the USB interface, any person can use a mobile phone to input/output large amount of data rapidly into/from and to the computer under the current condition frequently and conveniently.

However, the data stored in the computers by users is not safely protected in such condition. Obviously, the current method cannot achieve the user requirements for data security and the data stored in the computer by user can be freely accessed by anyone. To overcome the foregoing shortcomings and to meet the market requirements, the inventor of the present invention found a solution to effectively and fully protect the confidential data in a computer from being disclosed.

### SUMMARY OF THE INVENTION

In view of the mobility of mobile phones and most of the mobile phone hardware being equipped with the USB interface, anyone can use a mobile phone to transfer a large quantity of data with a computer rapidly. However, this method is unable to protect the data stored in the computer by users, and the data can be accessed by anyone freely, which causes an unauthorized disclosure of confidential data and brings tremendous inconvenience to users. Therefore, the inventor of the present invention based on year of experience in the related industry to conduct extensive researches and experiments and finally came up with the present invention that overcomes the foregoing shortcomings.

It is therefore a primary objective of the present invention to provide a method of protecting a computer by adding a lock function to a mobile phone universal interface, and the method has following advantages:
1. Users' data stored in a computer can be fully protected and the level of security can be enhanced, so as to effectively prevent unauthorized access of data.
2. The add-on value of mobile phones can be improved.

The accomplishment of the above-mentioned object of the present invention will become apparent from the following description and its accompanying drawings which disclose illustrative an embodiment of the present invention, and are as follows:

### BRIEF DESCRIPTION OF THE DRAWINGS

FIG. 1 is a schematic view of the architecture of a preferred embodiment of the present invention;

FIG. 2 is a flow chart of a mobile phone being connected to a PC USB interface when the PC is under a normal mode according to a preferred embodiment of the present invention;

FIG. 3 is a flow chart of a mobile phone being connected to a PC USB interface when the PC is under a protected mode according to a preferred embodiment of the present invention; and

FIG. 4 is a flow chart of a mobile phone being disconnected from a PC USB interface when the PC is under a normal mode according to a preferred embodiment of the present invention.

### DETAILED DESCRIPTION OF THE PREFERRED EMBODIMENTS

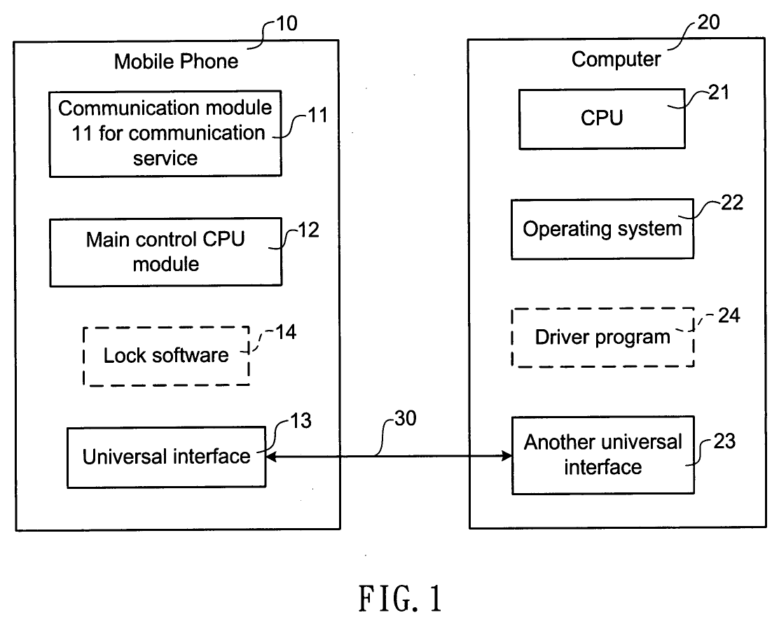

Referring to FIG. 1, the method of protecting a computer by adding a lock function to a mobile phone universal interface in accordance with the present invention comprises the steps of installing a lock software 14 in a mobile phone 10 for locking the universal interface 13, and installing a driver program 24 in the computer 20 for driving the lock software 14, so that after the lock software 14 of the mobile phone 10 is functioning and the mobile phone 10 is connected to the computer 20 having another universal interface 23 by a transmission wire 30, the protection program is run. After the computer 20 is disconnected from the mobile phone 10, the computer 20 displays an inquiry window to ask whether or not a user wants to lock the computer 20. If the user chooses yes, the computer 20 will enter into a protected mode, and the user has to reconnect the mobile phone 10 with the computer 20 through the transmission wire 30 and confirms the user's unique identification before the computer 20 can enter into a normal mode, and thus the data stored in the computer 20 can be protected in a more secure manner.

Referring to FIG. 1 for the structure of the present invention, again, the mobile phone 10 comprises a communication module 11 for providing a communication service, a main control CPU module 12, a universal interface 13 (the universal interface 13 is a USB in this embodiment), and a lock software 14 for locking the universal interface 13, so that users can choose to enable the functions of the lock software 14 by the lock software 14.

The computer 20 includes a CPU 21, an operating system 22 and another universal interface 23 for communicating with the universal interface 13, a driver program 24 for driving the lock software 14.

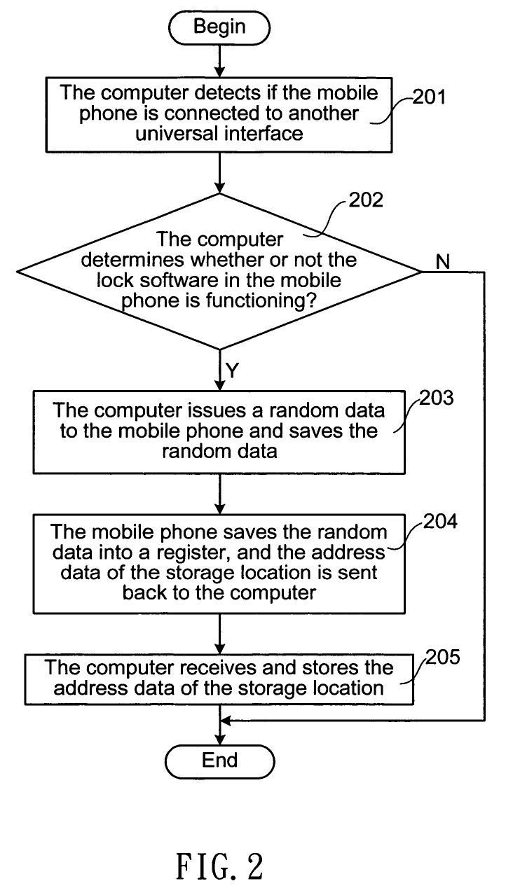

The mobile phone 10 with the lock software 14 function is described in details below. In FIG. 2, the computer 20 is working under normal condition, and the mobile phone 10 is connected to another universal interface 23 of the computer 20 through the transmission wire 30 (as shown in FIG. 1), the following procedure will be carried out:

Step 201: First of all, the computer 20 detects if the mobile phone 10 is connected to another universal interface 23;

Step 202: The computer 20 determines whether or not the lock software 14 in the mobile phone 10 is functioning. If it is on, go to Step 203, or else perform the regular processing;

Step 203: The computer 20 issues a random data to the mobile phone 10 and saves the random data;

Step 204: The mobile phone 10 saves the random data into a register (not shown in the figure), the storage location is random, and the address data of the storage location is sent back to the computer 20;

Step 205: The computer 20 receives and stores the address data of the storage location, and ends the procedure for this time.

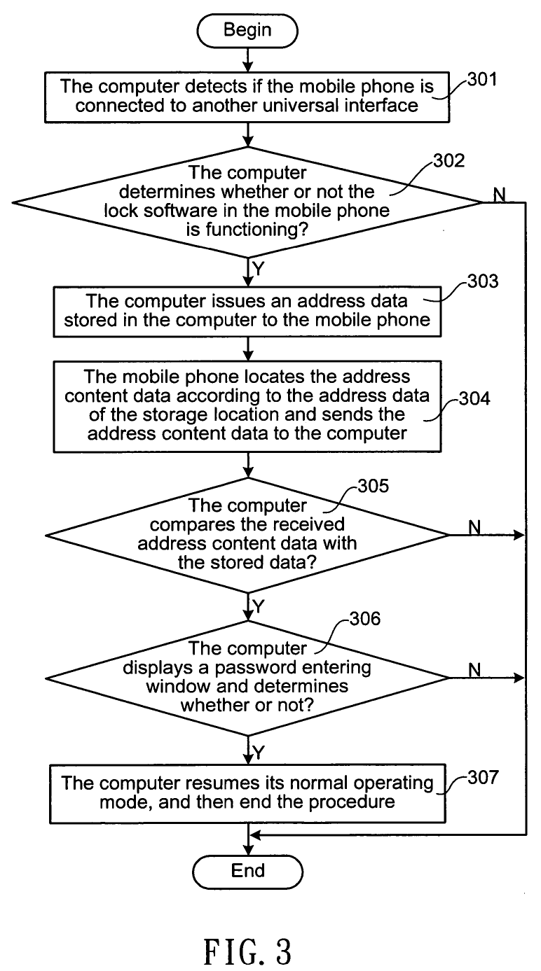

Further, if the computer 20 is already in the protected mode and the mobile phone 10 is connected to another universal interface 23 of the computer 20, the following procedure will be executed as shown in FIG. 3:

Step 301: First of all, the computer 20 detects if the mobile phone 10 is connected to another universal interface 23;

Step 302: The computer 20 determines whether or not the lock software 14 in the mobile phone 10 is functioning. If it is on, go to Step 303, or else do not process;

Step 303: The computer 20 issues an address data stored in the computer to the mobile phone 10, wherein the address data is the data address stored in the register and originally sent back from the mobile phone 10 to the computer 20;

Step 304: The mobile phone 10 locates the address content data according to the address data of the storage location and sends the address content data to the computer 20;

Step 305: The computer 20 compares the received address content data with the stored data to see if they are identical; if yes, then go to Step 306, or else do not process;

Step 306: The computer 20 displays a password entering window and determines whether or not the password is correct; if yes, then go to Step 307, or else return to the protected mode;

Step 307: The computer 20 resumes its normal operating mode, and then end the procedure for this time.

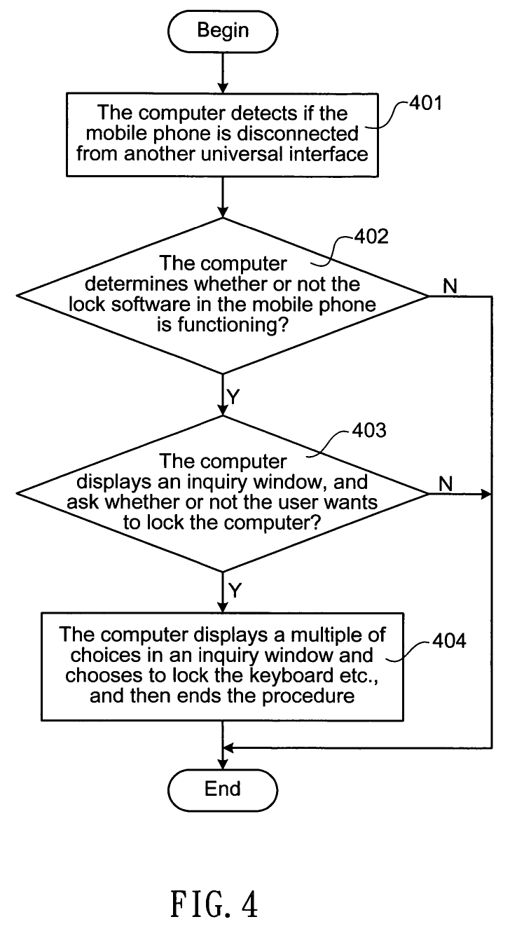

If the computer 20 is under a normal operating mode and the mobile phone 10 is disconnected, the following procedure will be executed as shown in to FIG. 4:

Step 401: The computer 20 detects if the mobile phone 10 is disconnected from another universal interface 23;

Step 402: The computer 20 determines whether or not the lock software 14 in the mobile phone 10 is functioning. If it is on, go to Step 403, or else do not process;

Step 403: The computer 20 displays an inquiry window, and ask whether or not the user wants to lock the computer 20; if yes, then go to Step 404, or else do not process but maintain the original condition;

Step 404: The computer 20 displays a multiple of choices in an inquiry window, and these choices include if it is necessary to lock the keyboard and mouse, the IrDA, the Bluetooth transmission, the wireless network, the cable network or other external interfaces, and lock the chosen one accordingly, and then end the procedure for this time.

If the computer 20 under protected mode is turned on by an unauthorized person, the computer 20 will remain in its protected mode after it is reset.

In the present invention, if a user unplugs the transmission wire 30 and disconnects the mobile phone 10 from the computer 20, the inquiry window will appear to ask whether or not the user wants to lock the computer 20. For an authorized user, the computer 20 will remain in its protected mode. The computer 20 can be turned on in a normal mode only by using the transmission wire 30 to connect the mobile phone 10 with the computer 20 and providing a correct identification. Further, a lock switch (not shown in the figure) can be installed on the mobile phone 10, so that users can choose whether to enable the lock function or not.

While a preferred embodiment of the invention has been shown and described in detail, it will be readily understood and appreciated that numerous omissions, changes and additions may be made without departing from the spirit and scope of the invention.

What is claimed is:

1. A method of protecting a computer by adding a lock function to a mobile phone universal interface, comprising the steps of:
installing a lock software in a mobile phone for locking a universal interface thereof, and
installing a driver program in a computer for driving said lock software, and
activating a protection program, when said lock software of said mobile phone is functioning and the mobile phone is connected to another universal interface of said computer through a transmission wire;
whereby, after said computer is disconnected from said mobile phone, said computer displays an inquiry window to ask whether to lock said computer or not; if a yes answer is inputted, said computer enters into a protected mode and will be activated into a normal mode only when said mobile phone is reconnected with said computer through said transmission wire and is confirmed as a unique identity.

2. The method of protecting a computer by adding a lock function to a mobile phone universal interface of claim 1, wherein, when said computer is operating under a normal mode and said mobile phone is connected to another universal interface of said computer through said transmission wire, the following procedure will be carried out:
said computer detects that said mobile phone is connected to said another universal interface;
said computer issues a random data to said mobile phone and saves said random data, when said computer examines to discover that said lock software in the mobile phone is functioning;
said mobile phone saves said random data into a register, and sends an address data of a storage location of said random data in the register back to said computer; and
said computer receives and saves said address data of said storage location.

3. The method of protecting a computer by adding a lock function to a mobile phone universal interface of claim 1, wherein, when said computer is operated under a protected mode and said mobile phone is connected to another universal interface of said computer, the following procedure is carried out:
said computer detects that said mobile phone is connected to said another universal interface;
said computer issues an address data of a storage location in said mobile phone to said mobile phone, when said computer examines to discover that said lock software in the mobile phone is functioning;
said mobile phone locates an address content data according to said address data of said storage location and issues said address content data back to said computer; and
said computer compares said address content data with said data stored in said computer, displays a password entering window when said address content data is identical to said data stored in said computer, and resumes into a normal mode when examining to discover that a password entered is correct.

4. The method of protecting a computer by adding a lock function to a mobile phone universal interface of claim 1, wherein, when said mobile phone is disconnected from said computer working under a normal mode, the following procedures will be executed:
said computer detects that the mobile phone is disconnected from said another universal interface;
the computer displays an inquiry window to ask whether to lock said computer or not, when said computer examines to discover that said lock software in the mobile phone is functioning; and
if a yes answer is entered, said computer displays multiple choices on said inquiry window and is locked in a way according to the choice being selected.
